(19) United States
(12) Patent Application Publication
(10) Pub. No.: US 2025/0244537 A1
(43) Pub. Date: Jul. 31, 2025

(54) OPTICAL WAVEGUIDE AND AUGMENTED REALITY DISPLAY DEVICE

(71) Applicants: SVG TECH GROUP CO., LTD., Suzhou (CN); SOOCHOW UNIVERSITY, Xuzhou (CN)

(72) Inventors: Minghui LUO, Suzhou (CN); Wen QIAO, Suzhou (CN); Ping ZHU, Suzhou (CN); Ruibin LI, Suzhou (CN); Ming YANG, Suzhou (CN); Linsen CHEN, Suzhou (CN)

(21) Appl. No.: 19/011,670

(22) Filed: Jan. 7, 2025

Related U.S. Application Data
(63) Continuation of application No. PCT/CN2023/082728, filed on Mar. 21, 2023.

(30) Foreign Application Priority Data
Jul. 7, 2022 (CN) 202210796277.4

(51) Int. Cl. G02B 6/34; G02B 27/01

(52) U.S. Cl. CPC G02B 6/34; G02B 27/0101

(57) ABSTRACT

An optical waveguide, comprising a waveguide substrate (10). A coupling-in area (20) and a coupling-out area (30) are provided on the waveguide substrate (10), the coupling-in area (20) is provided with a coupling-in grating (21), and the coupling-out area (30) comprises a first coupling-out area (31) and a second coupling-out area (32); a first coupling-out grating (41) is provided in the first coupling-out area (31), and a second coupling-out grating (42) is provided in the second coupling-out area (32); the coupling-in grating (21) and the second coupling-out grating (42) are one-dimensional gratings, and the first coupling-out grating (41) is a two-dimensional grating.

### TECHNICAL FIELD

The present invention relates to the technical field of augmented reality display, and in particular, to an optical waveguide and an augmented reality display device.

### BACKGROUND

Augmented Reality (AR) technology is a new technology that “seamlessly” integrates real world information and virtual world information. It not only displays real world information, but also simultaneously displays virtual information, the two types of information are mutually complemented and overlayed. In visualized augmented reality, a user use a helmet mounted display to recombine the real world with computer graphics, and thus can see the real world surrounding it.

Optical waveguides have a wide range of applications in the field of augmented reality due to their total reflection optical properties, and ultra-thin and surface-processable structures. Augmented reality display based on optical waveguides has become the mainstream display technology in the current industry. For example, HoloLens developed by Microsoft forms a display window based on butterfly shaped dilated pupil conduction, and has augmented reality display with a large field of view; augmented reality glasses developed by Magic Leap company in the United States are designed based on secondary unidirectional conductive optical waveguides, and achieve color display by combination of multiple pieces.

Augmented reality display based on optical waveguides can be applied not only in the field of near eye display, but also in car mounted head up display. At present, mainstream head up display is based on the principle of geometric optical spatial reflection, and has disadvantages such as a large front loading volume, a short virtual image viewing distance, a narrow eye movement range, and so on. Augmented reality head up display based on optical waveguides, by increasing surface areas of optical waveguides, can achieve advantages such as a small front loading volume, a far virtual image viewing distance, a large eye movement range, a large angle of view field, and so on, and is a key display technology for intelligent driving and human vehicle interaction.

### SUMMARY OF THE DISCLOSURE

### Technical Problem

A commonly used grating waveguide structure adopting “coupling in”—“turning”—“coupling out” in the prior art is as shown in FIG. 1, the grating waveguide structure includes a waveguide substrate 1, and a coupling-in area 2, a turning area 3, and a coupling-out area 4 which are arranged on the waveguide substrate 1. Gratings are arranged in the coupling-in area 2, the turning area 3, and the coupling-out area 4. Image light is incident from the coupling-in area 2 and undergoes diffraction in the coupling-in area 2, the light that meets the total reflection condition is transmitted through total reflection in the waveguide substrate 1 to the turning area 3. The light interacts with the grating in the turning area 3 and achieves bending of optical path. The bent light continues to be transmitted in the form of total reflection transmission to the coupling-out area 4 and finally coupled out to human eyes from the coupling-out area 4 to achieve virtual imaging. In the above process, the light propagating from the coupling-in area 2 to the turning area 3 achieves stretching and expansion in the x-axis direction, and the light propagating from the turning area 3 to the coupling-out area 4 achieves stretching and expansion in the y-axis direction, thereby achieving pupil expansion in two-dimensional space. However, in the existing technology, the coupling-in area 2, the turning area 3, and the coupling-out area 4 used for conducting light have island designs in designs of pupil expansion and coupling-out, there is a lot of waste during the light conduction process, leading to low overall coupling-out efficiency and large limitation in the exit pupil range.

### Technical Solution

A purpose of the invention is to provide an optical waveguide that can not only improve overall use efficiency but also maximize the expansion of the exit pupil range.

The present invention provides an optical waveguide comprising a waveguide substrate, wherein the waveguide substrate is provided thereon with a coupling-in area and a coupling-out area, the coupling-in area is provided with a coupling-in grating, the coupling-out area comprises a first coupling-out area and a second coupling-out area, the first coupling-out area is provided therein with a first coupling-out grating, and the second coupling-out area is provided therein with a second coupling-out grating; the coupling-in grating and the second coupling-out grating are one-dimensional gratings, and the first coupling-out grating is a two-dimensional grating.

Furthermore, the second coupling-out area comprises a first sub-area and a second sub-area, the second coupling-out grating comprises a first sub-grating and a second sub-grating, the first sub-grating is arranged in the first sub-area, and the second sub-grating is arranged in the second sub-area.

Furthermore, the first sub-area and the second sub-area are symmetrically arranged at two sides of the first couping-out area.

Furthermore, a grating orientation of the coupling-in grating is consistent with a width direction of the waveguide substrate; the first coupling-out grating has a first grating orientation M and a second grating orientation N arranged in a cross pattern; a grating orientation of the first sub-grating is the same as the first grating orientation M, and a grating orientation of the second sub-grating is the same as the second grating orientation N.

Furthermore, an included angle between the first grating orientation M and the second grating orientation N is 90°-160°.

Furthermore, the coupling-in area, the first coupling-out area, the first sub-area, and the second sub-area are all rectangular; the coupling-in area and the first coupling-out area have the same width and are located at the same position in a width direction of the waveguide substrate; widths of the first sub-area and of the second sub-area are less than or equal to the width of the first coupling-out area, and lengths of the first sub-area, of the second sub-area, and of the first coupling-out area are identical.

Furthermore, the first coupling-out area is divided into multiple regions along a direction from approaching the coupling-in area to moving away from the coupling-in area, and gratings in the multiple regions have different depths and duty ratios; the first sub-area is divided into multiple regions along a direction from approaching the first coupling-out area to moving away from the first coupling-out area, and gratings in the multiple regions have different depths and duty ratios; the second sub-area is divided into multiple regions along a direction from approaching the first coupling-out area to moving away from the first coupling-out area, and gratings in the multiple regions have different depths and duty ratios.

Furthermore, the coupling-in grating, the first coupling-out grating, and the second coupling-out grating are located at the same surface of the waveguide substrate.

Furthermore, the first coupling-out grating is a nanodot matrix structure, and the coupling-in grating and the second coupling-out grating are nanowire structures.

The present invention further provides an augmented reality display device comprising the aforementioned optical waveguide.

### Advantage Effect

The optical waveguide provided by the present invention is provided with the one-dimensional coupling-in grating in the coupling-in area of the waveguide substrate, the coupling-out area includes the first coupling-out area and the second coupling-out area, the first coupling-out area is provided therein with the two-dimensional first coupling-out grating, and the second coupling-out area is provided therein with the one-dimensional second coupling-out grating; the optical waveguide is coupled in by one-dimensional gratings and coupled out by hybrid gratings, and light propagates by pupil expansion from point to surface in the optical waveguide. Compared with existing augmented reality display solutions of optical waveguides, the optical waveguide of the present invention does not need to set a turning grating, and has characteristics such as a high bandwidth, high interconnectivity, inherent parallel processing, etc. For continuously input light, conduction similar to neural network interconnection is formed, and it is coupled out at the same time of expanding the pupil, from point to surface; thus not only is the overall use efficiency improved, but also the expansion of the exit pupil range is maximized.

### BRIEF DESCRIPTION OF THE DRAWINGS

FIG. 1 is a schematic view of a commonly used grating waveguide structure adopting “coupling in”-“turning”-“coupling out” in the prior art.

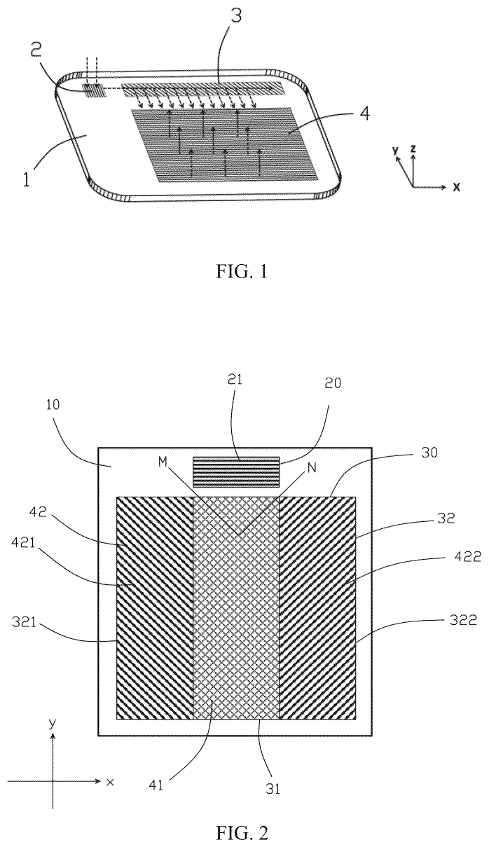

FIG. 2 is a structural schematic view of an optical waveguide of a preferred embodiment of the present invention.

FIG. 3 is a schematic view of light conduction in an optical waveguide of a preferred embodiment of the present invention.

FIG. 4 is another schematic view of light conduction in an optical waveguide of a preferred embodiment of the present invention.

FIG. 5a to FIG. 5d are schematic views of combination manners of image light source incidence and human eye observation in an optical waveguide of a preferred embodiment of the present invention.

FIG. 6 is a coupling simulation view aiming at a coupling-in area of an optical waveguide of a preferred embodiment of the present invention when incidence light enters.

FIG. 7 is a schematic view of conduction of diffraction light generated in

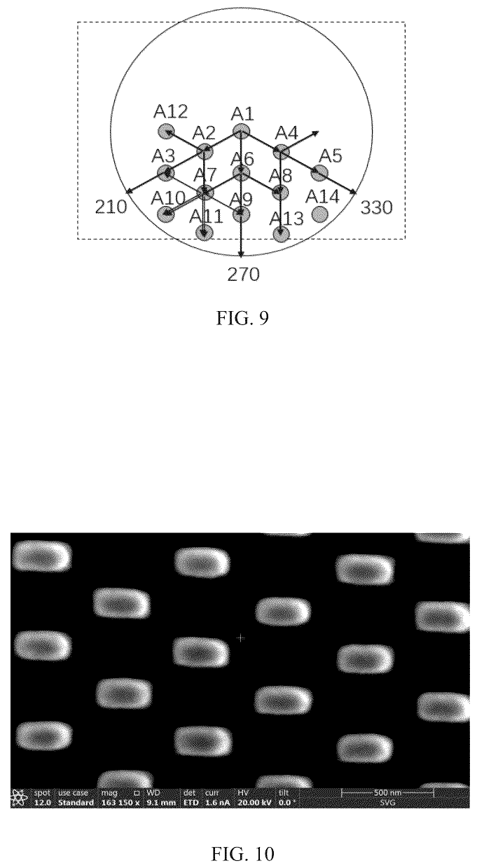

FIG. 6 in an optical waveguide.

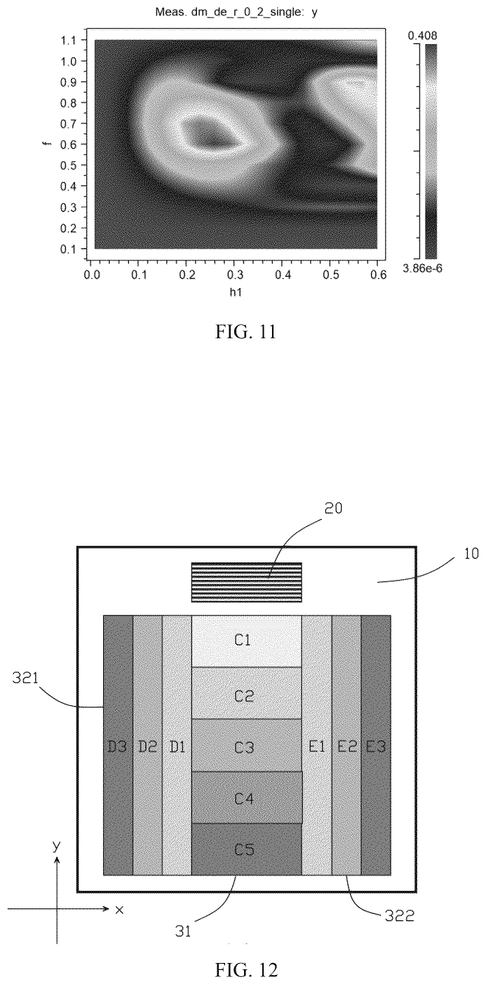

FIG. 8 is a diffraction simulation view of FIG. 7.

FIG. 9 further shows a schematic view of light conduction in a first coupling-out area.

FIG. 10 is a scanning electron microscope image of a first coupling-out area.

FIG. 11 is a trend graph of diffraction light with the azimuth angle 270 marked by the black block B in FIG. 8 in a range with a duty ratio 0.1-1.1 and a depth 50 nm-600 nm.

FIG. 12 is a structural schematic view of an optical waveguide of another embodiment of the present invention.

### DETAILED DESCRIPTION

Specific implementations of the present invention are further described in detail below in combination with the drawings and the embodiments. The following embodiments are used to illustrate the present invention, but not used to limit the scope of the present invention.

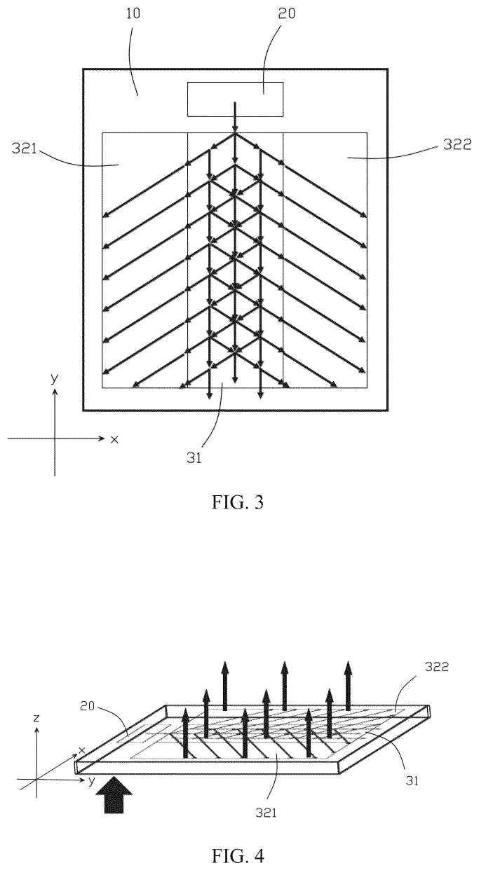

FIG. 2 is a structural schematic view of an optical waveguide of a preferred embodiment of the present invention. Referring to FIG. 2, an optical waveguide provided by this embodiment includes a waveguide substrate 10, the waveguide substrate 10 is provided thereon with a coupling-in area 20 and a coupling-out area 30, the coupling-in area 20 is provided with a coupling-in grating 21, and the coupling-out area 30 is provided with coupling-in gratings; the coupling-out area 30 includes a first coupling-out area 31 and a second coupling-out area 32, the first coupling-out area 31 is provided therein with a first coupling-out grating 41, and the second coupling-out area 32 is provided therein with a second coupling-out grating 42.

The waveguide substrate 10 has high transmittance in the visible wavelength range,, and can be made of materials such as glass or resin.

Specifically, the second coupling-out area 32 includes a first sub-area 321 and a second sub-area 322, the second coupling-out grating 42 includes a first sub-grating 421 and a second sub-grating 422, the first sub-grating 421 is arranged in the first sub-area 321, and the second sub-grating 422 is arranged in the second sub-area 322.

Furthermore, the first sub-area 321 and the second sub-area 322 are symmetrically arranged at two sides of the first couping-out area 31.

In this embodiment, the first coupling-out grating 41 is a two-dimensional grating, and the coupling-in grating 21 and the second coupling-out grating 42 are one-dimensional gratings. That is, the grating in the coupling-out area 30 is a hybrid grating, the middle is a two-dimensional grating, and the left and the right are one-dimensional gratings. A one-dimensional grating is composed of multiple one-dimensional grating units, and the one-dimensional grating has grating orientation in a single direction. A two-dimensional array grating is composed of multiple two-dimensional grating units, the multiple two-dimensional grating units have grating orientation in two directions and are arranged in an array.

Furthermore, the first coupling-out grating 41 is a nano lattice structure, individual units of the nano lattice structure can be any regular or irregular shape such as a cylinder, a square post, a trapezoidal post, etc., and are arranged in a periodic manner. The coupling-in grating 21 and the second coupling-out grating 42 are nanowire structures, the nanowire structures are linear structures, which can be regular rectangles and can also be irregular shapes, and are also arranged in a periodic manner. They can be prepared using holographic interferometry technology, photolithography technology, or nanoimprint technology.

Furthermore, an x direction is defined as a width direction of the waveguide substrate 10 in the drawings, a y direction is defined as a length direction of the waveguide substrate 10 in the drawings, and a z direction is defined as a thickness direction of the waveguide substrate 10. Among them, the coupling-in grating 21 has a grating orientation (i.e., a channel direction of the grating); in this embodiment, a grating orientation of the coupling-in grating 21 is consistent with the x direction, that is, consistent with the width direction of the waveguide substrate 10.

The first coupling-out grating 41 has two grating orientations arranged in a cross pattern, which include a first grating orientation M and a second grating orientation N; in this embodiment, a grating orientation of the first sub-grating 421 is the same as the first grating orientation M, and a grating orientation of the second sub-grating 422 is the same as the second grating orientation N.

Furthermore, an orientation included angle of the first coupling-out grating 41 (i.e., an included angle between the first grating orientation M and the second grating orientation N) is 90°-160°. Specifically, for example, the first grating orientation M and the x direction form a 150° included angle, and the second grating orientation N and the x direction form a 30° included angle.

Furthermore, the coupling-in area 20, the first coupling-out area 31, the first sub-area 321, and the second sub-area 322 are all rectangular. The coupling-in area 20 and the first coupling-out area 31 have the same width and are located at the same position in the width direction of the waveguide substrate 10 (the x direction); but in the y direction, the first coupling-out area 31 is under the coupling-in area 20. Widths of the first sub-area 321 and of the second sub-area 322 in the x direction are less than or equal to the width of the first coupling-out area 31 in the x direction, and the first sub-area 321, the second sub-area 322, and the first coupling-out area 31 have the same height and are located at the same position in the y direction.

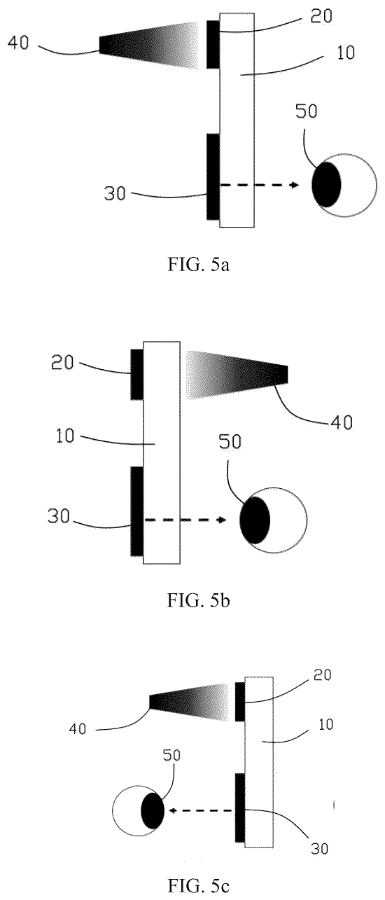

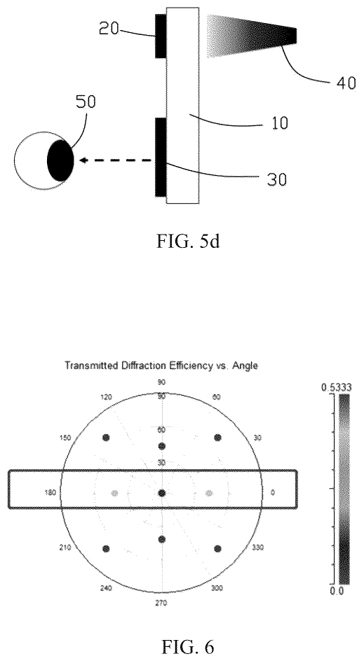

FIG. 3 is a schematic view of light conduction in an optical waveguide of a preferred embodiment of the present invention, FIG. 4 is another schematic view of light conduction in an optical waveguide of a preferred embodiment of the present invention. Referring to FIG. 3 and FIG. 4 together, when image light is coupled by the coupling-in area 20 and conducted towards the coupling-out area 30, it enters the first coupling-out area 31 in the middle of the coupling-out area 30 at first. The first coupling-out grating 41 in the first coupling-out area 31 is a nano lattice structure, the coupled-in and conducted light enters the first coupling-out grating 41 obliquely by a certain angle; the first coupling-out grating 41 has light diffusing in the optical waveguide along multiple directions, which include coupling-out leftwards, coupling-out rightwards, and coupling-out in the middle; light continuously conducts multi-directional diffusion in specific directions during the coupling-out and conducting process in the first coupling-out area 31, thereby realizing the function of expanding pupils while conducting. Additionally, the conducted light coupled-out from the left and the right is conducted along the original direction while being coupled-out. Therefore, the optical waveguide of the present invention has middle coupling-out and coupling-out at both left and right sides.

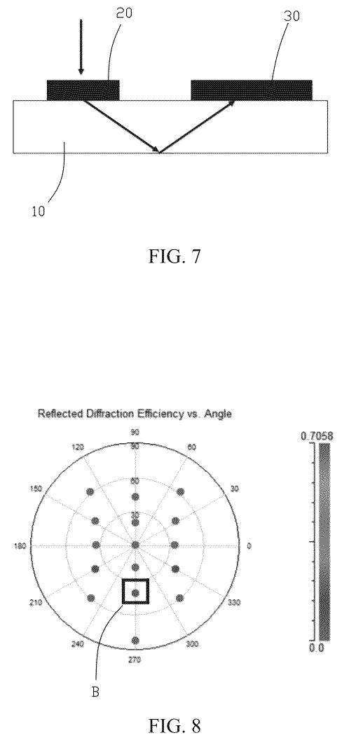

Furthermore, the coupling-in grating 21, the first coupling-out grating 41, and the second coupling-out grating 42 are located at the same surface of the waveguide substrate 10, but are not limited to this. As shown in FIG. 5a to FIG. 5d, in the optical waveguide, it is possible that an image light source 40 is incident from a structural surface (the surface provided with the coupling-in grating 21 and the coupling-out gratings), and a human eye 50 observes from a non-structural surface (the surface not provided gratings) at another side; or that the image light source 40 is incident from the non-structural surface, and the human eye 50 is at the same side as the image light source 40; or that the image light source 40 is incident from the structural surface, and the human eye 50 is at the same side as the image light source 40; or that the image light source 40 is incident from the non-structural surface, and the human eye 50 observes from the structural surface.

FIG. 6 is a coupling simulation view aiming at a coupling-in area of an optical waveguide of a preferred embodiment of the present invention when incidence light enters, FIG. 7 is a schematic view of conduction of diffraction light generated in FIG. 6 in an optical waveguide. Referring to FIG. 6 and FIG. 7 together, when light enters the coupling-in area 20 from the air, the coupling-in grating 21 in the coupling-in area 20 is a one-dimensional nanowire structure and has positive and negative first-order diffraction patterns. When light with an incident wavelength 520 nm enters normally, that is, enters the coupling-in area 20 perpendicularly, in generated diffraction light, diffraction light in a direction being perpendicular to the grating orientation of the coupling-in grating 21 is conducted to the coupling-out area 30.

FIG. 8 is a diffraction simulation view of FIG. 7. As shown in FIG. 8, light coming from coupling-in diffraction in FIG. 7 will enter and be coupled-out, at this time, light with azimuth angles 210, 270, and 330 will be mainly generated. Among them, light with an azimuth angle 210 will continue to be conducted and coupled-out from the left, light with an azimuth angle 270 will continue to be conducted and coupled-out from the middle, and light with an azimuth angle 330 will continue to be conducted and coupled-out from the right.

FIG. 9 further shows a schematic view of light conduction in a first coupling-out area. Referring to FIG. 9, light passing through the point Al will generate light beams A2, A6, A4, the A2 light beam will continue to conduct, contact the next nano lattice, and generate light beams A12, A3, A7; the A6 light beam conducts to generate light beams A7, A9, A8. This cycle repeats itself like this, large scale diffraction clusters can be formed at the 210 direction, the 270 direction, and the 330 direction; at the same time, the 210 direction and the 330 direction are in correspondence with left coupling-out and right coupling-out areas. A scanning electron microscope image of the first coupling-out area 31 are as shown in FIG. 10.

FIG. 11 is a trend graph of diffraction light with the azimuth angle 270 marked by the black block B in FIG. 8 in a range with a duty ratio 0.1-1.1 and a depth 50 nm-600 nm. The purpose of FIG. 11 is to analyze diffraction characteristics from above to below of the first coupling-out area 31. It can be seen that along with increase of the depth and decrease of the duty ratio, the efficiency of the azimuth angle 270 can change from small to big.

In order to ensure uniformity of coupled-out light of the whole coupling-out area 30, it is necessary to control the structure of the coupling-out area 30. FIG. 12 is a structural schematic view of an optical waveguide of another embodiment of the present invention. Referring to FIG. 12, in the optical waveguide, the structure of the whole coupling-out area 30 can be planned according to conduction efficiency at different duty cycles and different depths. For example, modulation for depths and shapes is performed according to areas to improve uniformity of light coupling-out intensity within each area.

Specifically, the first coupling-out area 31 is divided into multiple regions along a direction from approaching the coupling-in area 20 to moving away from the coupling-in area 20 (in the y direction, from above to below), and gratings in the multiple regions have different depths and duty ratios. For example, the first coupling-out area 31 is divided into five regions C1, C2, C3, C4, C5; wherein from C1 to C5, depths gradually increase, and/or duty ratios gradually decrease.

The first sub-area 321 is divided into multiple regions along a direction from approaching the first coupling-out area 31 to moving away from the first coupling-out area 31 (in the x direction, from right to left), and gratings in the multiple regions have different depths and duty ratios. For example, the first sub-area 321 is divided into three regions D1, D2, D3; wherein from D1 to D3, depths gradually increase, and/or duty ratios gradually decrease.

The second sub-area 322 is divided into multiple regions along a direction from approaching the first coupling-out area 31 to moving away from the first coupling-out area 31 (in the x direction, from left to right), and gratings in the multiple regions have different depths and duty ratios. For example, the second sub-area 322 is divided into three regions E1, E2, E3; wherein from E1 to E3, depths gradually increase, and/or duty ratios gradually decrease.

The present invention relates to an augmented reality display device including the aforementioned optical waveguide. Other structures of the augmented reality display device are well-known to those skilled in the art and will not be elaborated here.

The optical waveguide provided by the present invention is coupled in by one-dimensional gratings and coupled out by hybrid gratings, and light propagates by pupil expansion from point to surface in the optical waveguide. Compared with existing augmented reality display solutions of optical waveguides, the optical waveguide of the present invention does not need to set a turning grating, and has characterstics such as a high bandwidth, high interconnectivity, inherent parallel processing, etc. For continuously input light, conduction similar to neural network interconnection is formed, and it is coupled out at the same time of expanding the pupil, from point to surface; thus not only is the overall use efficiency improved, but also the expansion of the exit pupil range is maximized.

In the accompanying drawings, dimensions and relative sizes of layers and regions may be exaggerated for clarity. It should be understood that when an element, such as a layer, region, or substrate, is referred to as “formed on”, “set on”, or “located on” another element, the element may be directly set on the other element, or there may also exist intermediate elements. On the contrary, when an element is referred to as “directly formed on” or “directly set on” another element, there is no intermediate element.

In this article, unless otherwise explicitly specified and limited, the terms “mount”, “interconnect”, “connect”, and the like should be broadly understood, for example, they can be fixed connections, and can also be detachable connections, or integral connections; they can be mechanical connection, and can also be electrical connections; they can be direct connections, and can also be indirect connections through intermediate media; they can also be internal connections between two elements. For ordinary technical personnel in this field, specific meanings of the above terms can be understood according to specific situations.

In this article, directions or positional relationships indicated by the terms “up”, “down”, “front”, “back”, “left”, “right”, “top”, “bottom”, “inside”, “outside”, “vertical”, “horizontal”, and the like are based on the directions or positional relationships shown in the accompanying drawings, and are only used for expressing technical solutions clearly and describing conveniently, therefore cannot be understood as limiting the present invention.

In this article, the sequence adjectives “first”, “second”, and the like used to describe elements are only used to distinguish elements with similar attributes, and do not mean that the described components must follow a given order, or limitation by time, space, level, or other factors.

In this article, unless otherwise specified, “multiple” and “a plurality of” mean two or more than two.

In this article, the terms “include”, “comprise”, or any other variation thereof are intended to encompass non-exclusive inclusion; in addition to including those essential factors listed, other essential factors not explicitly listed can also be included.

The above description is only a specific implementation of the present invention, but the protection scope of the present invention is not limited to this. Any changes or replacements that can easily be considered by technicians familiar with the technical field within the technical scope disclosed by the present invention should be covered within the protection scope of the present invention. Therefore, the protection scope of the present invention should be based on the protection scope of the attached claims.

What is claimed is:

1. An optical waveguide comprising a waveguide substrate, wherein the waveguide substrate is provided thereon with a coupling-in area and a coupling-out area, the coupling-in area is provided with a coupling-in grating, the coupling-out area comprises a first coupling-out area and a second coupling-out area, the first coupling-out area is provided therein with a first coupling-out grating, and the second coupling-out area is provided therein with a second coupling-out grating; the coupling-in grating and the second coupling-out grating are one-dimensional gratings, and the first coupling-out grating is a two-dimensional grating.

2. The optical waveguide according to claim 1, wherein the second coupling-out area comprises a first sub-area and a second sub-area, the second coupling-out grating comprises a first sub-grating and a second sub-grating, the first sub-grating is arranged in the first sub-area, and the second sub-grating is arranged in the second sub-area.

3. The optical waveguide according to claim 2, wherein the first sub-area and the second sub-area are symmetrically arranged at two sides of the first couping-out area.

4. The optical waveguide according to claim 2, wherein a grating orientation of the coupling-in grating is consistent with a width direction of the waveguide substrate; the first coupling-out grating has a first grating orientation M and a second grating orientation N arranged in a cross pattern; a grating orientation of the first sub-grating is the same as the first grating orientation M, and a grating orientation of the second sub-grating is the same as the second grating orientation N.

5. The optical waveguide according to claim 4, wherein an included angle between the first grating orientation M and the second grating orientation N is 90°-160°.

6. The optical waveguide according to claim 2, wherein the coupling-in area, the first coupling-out area, the first sub-area, and the second sub-area are all rectangular; the coupling-in area and the first coupling-out area have the same width and are located at the same position in a width direction of the waveguide substrate;
widths of the first sub-area and of the second sub-area are less than or equal to the width of the first coupling-out area, and lengths of the first sub-area, of the second sub-area, and of the first coupling-out area are identical.

7. The optical waveguide according to claim 2, wherein the first coupling-out area is divided into multiple regions along a direction from approaching the coupling-in area to moving away from the coupling-in area, and gratings in the multiple regions have different depths and duty ratios; the first sub-area is divided into multiple regions along a direction from approaching the first coupling-out area to moving away from the first coupling-out area, and gratings in the multiple regions have different depths and duty ratios; the second sub-area is divided into multiple regions along a direction from approaching the first coupling-out area to moving away from the first coupling-out area, and gratings in the multiple regions have different depths and duty ratios.

8. The optical waveguide according to claim 1, wherein the coupling-in grating, the first coupling-out grating, and the second coupling-out grating are located at the same surface of the waveguide substrate.

9. The optical waveguide according to claim 1, wherein the first coupling-out grating is a nanodot matrix structure, and the coupling-in grating and the second coupling-out grating are nanowire structures.

10. An augmented reality display device comprising the optical waveguide according to claim 1.
